(19) United States
(12) Patent Application Publication
(10) Pub. No.: US 2010/0014671 A1
(43) Pub. Date: Jan. 21, 2010

(54) SECURE INTERCHIP TRANSPORT INTERFACE

(75) Inventor: Paul Moroney, Olivenhain, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/142,180

(22) Filed: Jun. 19, 2008

(51) Int. Cl. H04L 9/00

(52) U.S. Cl. 380/262; 725/31

(57) ABSTRACT

Multimedia content or related data is securely transferred between a source device and a sink device in a secure multimedia content delivery device, such as a set-top box, using keys modified by logically combining them with copy control-related bits associated with the data.

### BACKGROUND OF THE INVENTION

1. Field of the Invention

The invention relates generally to digital rights management, conditional access, and cryptographic processing of content in a secure multimedia content delivery device such as a set-top box and, more specifically, to securely transferring data between chips or modules internal to such a device.

2. Description of the Related Art

So-called “broadband” digital communication services allow users (i.e., subscribers to the services) to receive multimedia (i.e., video, audio, etc.) content, such as movies and music, on their computers, set-top boxes (STBs), wireless handsets, residential gateways and similar user devices. The terms “conditional access” (CA) and “digital rights management” (DRM) refer to the protection of such content by requiring certain criteria to be met before granting access to the content. For example, cable television and similar systems have long included CA schemes in which content is transmitted in encrypted form. The STBs at subscriber premises have decryption keys that are provisioned in the STB at the time of manufacture, stored in a plug-in card provided to the subscriber along with the STB by the service provider, and/or remotely transmitted to the STB.

An example of such a DRM scheme is the Digital Transmission Content Protection (DTCP) specification, which defines a cryptographic protocol for protecting multimedia entertainment (e.g., television) content from unauthorized interception and copying as it is transferred from a “source device” to a “sink device.” The DTCP specification specifies the inclusion in the content data stream of Copy Control Information (CCI), including Encryption Mode Indicator (EMI) bits. The EMI bits constitute the two most-significant bits of the synchronization field of the packet header. The EMI bits are encoded to specify one of the following four states: copy freely; copy never; copy one generation; and no more copies.

As illustrated in FIG. 1, a conventional STB 10 includes a communications section 12 with a tuner 14 and demodulator 16, and a security section 18 with a decryptor 20 and a CableCard™ 22. (As known in the art, a CableCard™ is a plug-in card that allows consumers in the United States to use certain devices other than those provided by the cable television company to access the cable television company's network.) Decryptor 20 applies the appropriate decryption key (not shown), and outputs the decrypted (or unencrypted or clear) data stream to the decoder 24, which applies MPEG-2 decoding. (MPEG-2 is an encoding scheme promulgated by the Motion Picture Expert Group (MPEG) and has become the standard for digital television systems.) Decoder 24 outputs the decoded data to any of various interfaces commonly included in such STBs, such as a High Definition Multimedia (HDMI) device 26 and an IEEE-1394 interface device 28. HDMI interface device 26 is a digital video and audio protocol device that conforms to the HDMI standard promulgated by the HDMI industry consortium. IEEE-1394 interface device 28 is a high-speed serial data interface device that conforms to the IEEE-1394 standard promulgated by the Institute of Electrical and Electronics Engineers (IEEE). The general operation of STB 10 is controlled by a central processor system 30 in accordance with suitable software or firmware programming.

A concern is that while the content arriving at STB 10 over the broadcast link (e.g., cable, fiber, etc.) from the service provider is encrypted and otherwise protected in accordance with various conditional access schemes and thus resistant to interception and copying, the data streams exiting decryptor 20 and decoder 24 are not encrypted and thus subject to interception by unscrupulous individuals probing the circuitry inside STB 10. While in many conventional STB implementations, decryptor 20 is internal to an integrated circuit chip (e.g., a decoder “system-on-a-chip” or “SoC”) and thus protected from tampering, this may not be true of the link to the IEEE-1394 device.

### BRIEF DESCRIPTION OF THE DRAWINGS

FIG. 1 is a block diagram of an STB in accordance with the prior art.

FIG. 2 is a block diagram of an STB in which data is securely transferred between a decoder SoC and an IEEE-1394 device.

FIG. 3 is a flow diagram illustrating a method for securely transferring data between the decoder SoC and the IEEE-1394 device.

FIG. 4 is a flow diagram similar to FIG. 3, illustrating an alternative method for securely transferring data from the IEEE-1394 interface device to the SoC in the STB of FIG. 2.

FIG. 5 is a flow diagram illustrating a method for making secure inter-chip data transport interfaces in STBs.

FIG. 6 is a flow diagram illustrating a method for securely transferring data from the SoC to a transcoder device in the STB of FIG. 2.

FIG. 7 is a flow diagram illustrating the conventional use of CCI bits in controlling copying of content.

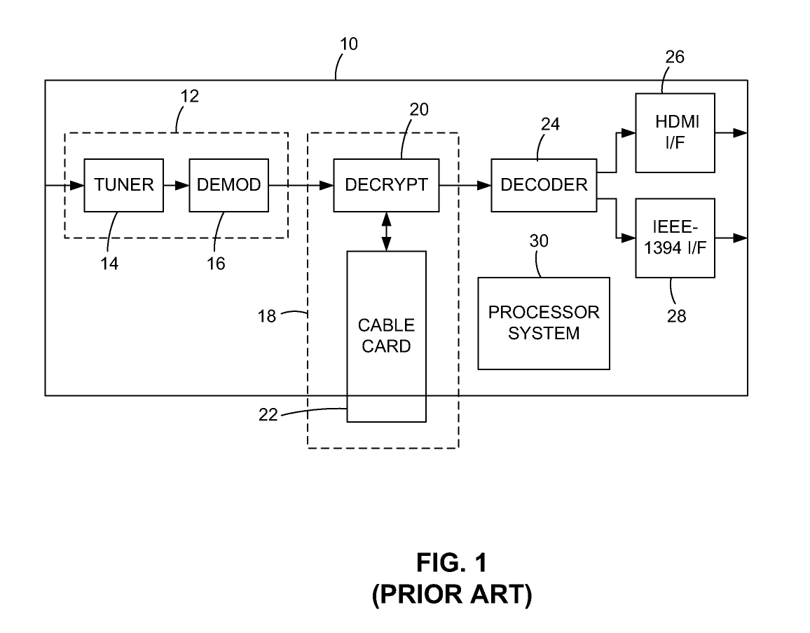

### DETAILED DESCRIPTION

In the following description, like reference numerals indicate like components to enhance the understanding of the systems, devices and methods for providing content interoperability between different digital rights management schemes through the description of the drawings. Also, although specific features, configurations, arrangements, and sequences of steps are discussed in this patent specification (“herein”), it should be understood that such specificity is for illustrative purposes only. A person skilled in the relevant art will recognize that other features, configurations, arrangements and steps are useful without departing from the spirit and scope of the invention.

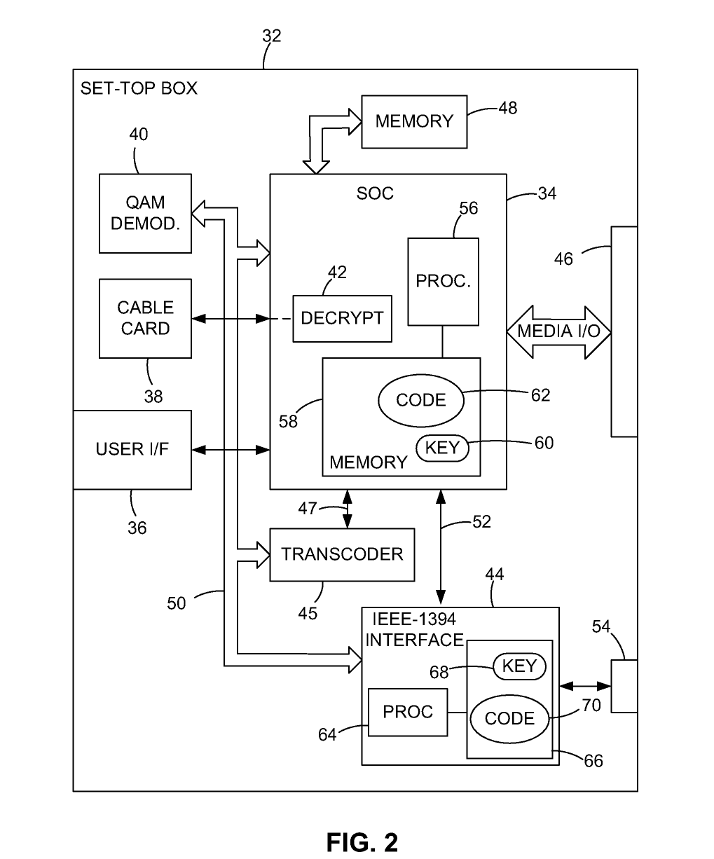

As illustrated in FIG. 2, the core processing functions of a set-top box (STB) 32, such as decrypting and decoding video content (data), are performed by an integrated circuit chip referred to herein as a “system-on-a-chip” (SoC) 34. In addition, functional elements that are typical of those included in such STBs but that are not included in SoC 34 include a user interface (e.g., buttons, display, infrared remote control interface, etc.) 36, a CableCard™ 38, a quadrature amplitude modulation (QAM) module 40, an IEEE-1394 interface device 44, and a transcoder 45. SoC 34 communicates signals with input sources and external media devices, such as a television, digital video recorder, etc., via a number of suitable connectors 46. SoC 34 has access to one or more memory devices 48, such as high-speed DDR (Double Data Rate) random access memory, non-volatile FLASH memory or any other suitable type of memory. STB 32 can further include any other elements of the types that are conventionally included in such STBs, but they are not shown for purposes of clarity.

IEEE-1394 interface device 44 is preferably a single integrated circuit chip or a module comprising one or more chips. It communicates with SoC 34 (i.e., another chip or module) via two buses: a Peripheral Component Interconnect (PCI) bus 50, and a four-wire serial bus 52. The four interfaces of the four-wire serial bus 52 are data, data_valid, clock and packet_sent. Serial bus 52 is a high-speed bus that carries the compressed multimedia (e.g., television) content between SoC 34 and IEEE-1394 interface device 44. It should be recognized that this bus may alternatively be implemented as two equivalent buses, one in each direction. Similarly, transcoder 45 communicates with SoC 34 via PCI bus 50 as well as a high-speed bus 47. With regard to PCI bus 50, as well known in the art to which the invention relates, the PCI standard is generally applied to buses that interface a computer motherboard or similar core processing system with peripheral devices. Accordingly, SoC 34 uses PCI bus 50 primarily to communicate control information, i.e., information other than the content being processed, with other elements of STB 32. IEEE-1394 interface device 44 communicates signals with external media devices, such as a television, digital video recorder, etc., via an IEEE-1394 connector 54.

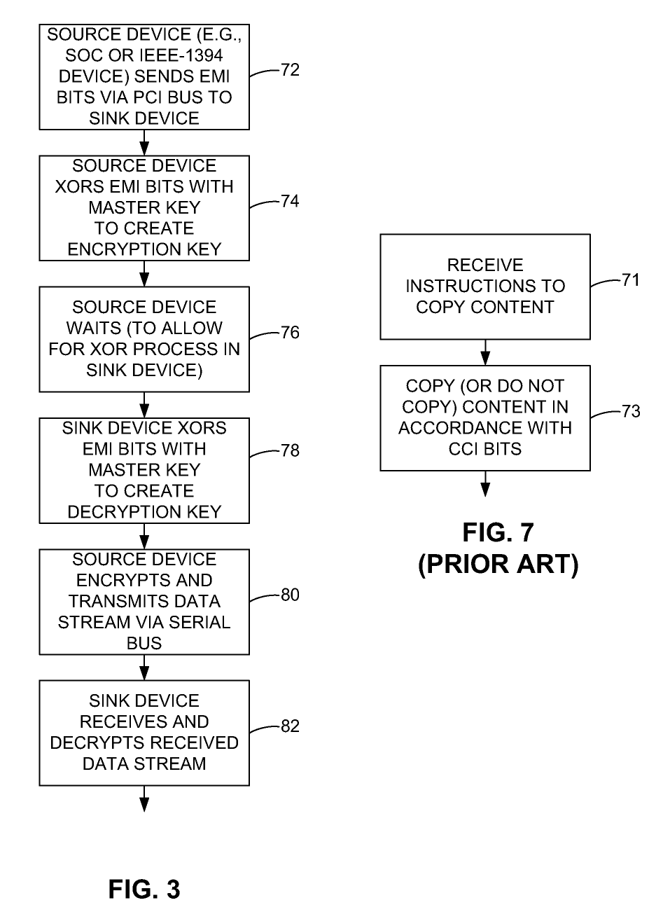

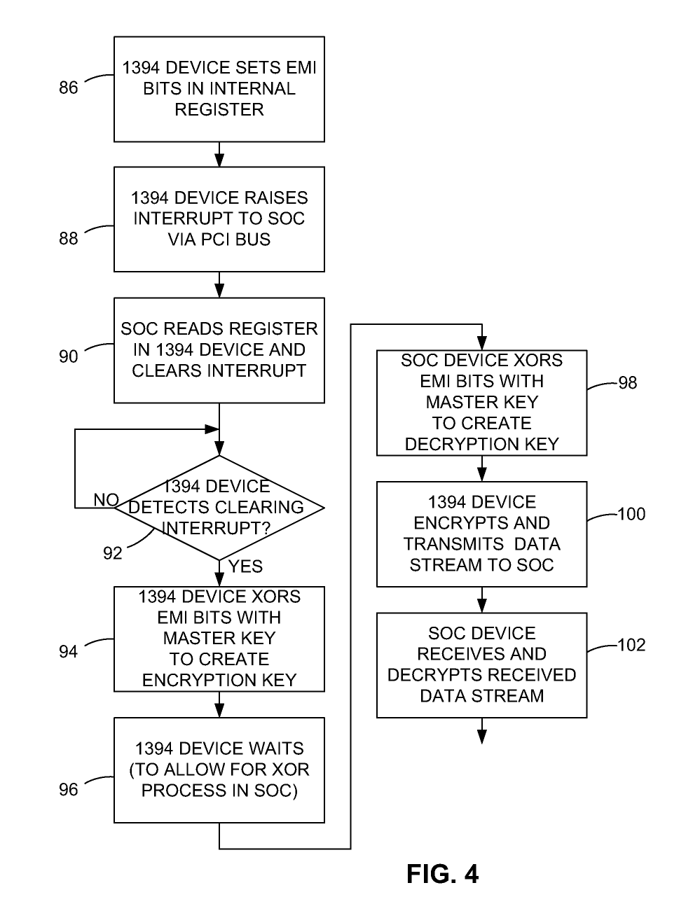

SoC 34 includes a decryptor 42, a processor 56, and working memory 58 (and may include other elements, not shown for purposes of clarity). Processor 56 and working memory 58 operate together such that SoC 34 can execute instructions in a computer-like manner. Further included in or associated with SoC 34 are software and data elements, including an SoC inter-chip security master key 60 and SoC inter-chip security software code 62. Processor 56 operates under control of code 62, i.e., instructions, to carry out the methods described below with regard to FIGS. 3-4. As persons skilled in the art appreciate, code 62 is conceptually shown as stored in or residing in memory 58 for purposes of illustration, and may not in actuality reside in memory 58 in its entirety or simultaneously with other such software elements. Rather, for example, in accordance with conventional computing paradigms, processor 56 may retrieve code 62 from external memory (e.g., DRAM or FLASH memory) 48 on an as-needed basis, in portions, for execution, in the manner well understood in the art. Similarly, under control of processor 56 or other element of SoC 34, master key 60 can be retrieved from memory 48 when needed. However, for purposes of understanding the invention, it is sufficient to note that SoC 34 has secure access to master key 60 in some suitable manner, regardless of how or where master key 60 is actually stored. “Secure” in this context means that master key 60 can be stored and accessed by SoC 34 in the same or similar manner in which decryption keys are conventionally stored in STBs.

It should be noted that the unique master key 60 that is provided in accordance with the invention is not the only key present in STB 34; rather, decryptor 42 uses another key (not shown) in the conventional manner to decrypt content in the conventional manner, using a decryption method typical to conventional STBs, such as the Advanced Encryption Standard (AES) with 128-bit key length (“AES-128”) or various other forms of the Data Encryption Standard (DES). The present invention does not relate to this conventional content decryption (by decryptor 42) but rather to additional encryption and decryption steps, described in further detail below, for securing data transferred between source and destination devices, such as between chips or modules in a set-top box or other multimedia content delivery device. In one exemplary embodiment, such data is securely transferred between SoC 34 and IEEE-1394 interface device 44 over serial bus 52.

IEEE-1394 interface device 44 similarly includes a processor 64 and working memory 66. Software or data elements of IEEE-1394 interface device 44, include an interface device inter-chip security master key 68 and interface device SoC inter-chip security software code 70. Processor 64 operates under control of software code 70 to effect the methods described below. It should be noted that interface device inter-chip security master key 68 is identical to SoC inter-chip security master key 60. Master keys 60 and 68 are unique in the sense that no keys identical to them are provisioned in any other STB manufactured.

Although in the illustrated embodiment of the invention SoC 34 has processor 56 that operates under control of software code 62, and IEEE-1394 interface device 44 has processor 64 that operates under control of software code 70, in other embodiments the respective chips or modules can have any other suitable type of processing logic programmed or configured in any other suitable manner (e.g., software, firmware, hard-wired logic, or combinations thereof) to carry out the methods described below.

A method for securely transferring (content) data between two chips or modules, such as SoC 34 and IEEE-1394 interface device 44, is illustrated in FIG. 3. In accordance with the method, one device acts as a data source, and the other acts as a data sink. In other words, the data stream flows from the source to the sink. The method is performed when the source device has data that is to be transferred to the sink device.

As indicated by step 72, the source device sends copy control-related bits to the sink device. For example, the source device (e.g., SoC 34) sends the Encryption Mode Indicator (EMI) bits associated with content that it has received from CableCard™ 38 to the sink device (e.g., IEEE-1394 interface device 44) via the (unsecure) PCI bus 50. As known in the art, EMI bits are part of the Copy Control Information (CCI) that is included in the content stream. Briefly referring to FIG. 7, the EMI bits are conventionally used when a device receives an instruction to copy content, as indicated by step 71. As known in the art, the EMI bits are encoded to specify one of the following four states: copy freely; copy never; copy one generation; and no more copies. The device then copies (or does not copy) the content in accordance with the state of the EMI bits, as indicated by step 73. Note that steps 71 and 73 are conventional and shown for reference purposes to provide a context for the use of the EMI bits or other copy control-related bits in the additional manner described below. As steps 71 and 73 relate to the conventional manner in which content is copied, they can be performed at any suitable time in relation to the other steps described herein.

Returning to FIG. 3, the source device forms an encryption key by performing a logical operation between the EMI bits and master key 60, as indicated by step 74. In the exemplary embodiment of the invention, the logical operation is an exclusive-OR, which is performed between the two EMI bits and the two least-significant bits of master key 60. However, in other embodiments, any other suitable logical operation can be employed, such as AND, OR, NOR, etc. As indicated by step 76, the source device waits or delays a predetermined amount of time, to allow the sink device to form a decryption key in the same manner. Thus, as indicated by step 78, the sink device forms a decryption key by performing an exclusive-OR logical operation between the EMI bits and master key 68 in the same manner as the source device. As the two master keys 60 and 68 are identical, the resulting encryption and decryption keys will be identical.

As indicated by step 80, the source device (e.g., SoC 34) encrypts the (content) data stream and transmits it via serial bus 52 to the sink device (e.g., IEEE-1394 interface device 44). In the typical case of an MPEG-2 transport stream, the MPEG standard defines how such encryption is to be signaled. SoC 34 can use any suitable encryption algorithm, such as AES-128, and the encryption key formed at step 74. (Note that in an embodiment in which AES-128 is used, master keys 60 and 68, and the resulting encryption and decryption keys, would each have 128 bits.) It should be noted that the step of the source device waiting or delaying between transferring the EMI or other copy control-related bits and transmitting encrypted content does not preclude an embodiment in which the source device initially transmits some content in unencrypted form and then, after waiting, begins to encrypt the content it is transmitting.

As indicated by step 82, the sink device receives and decrypts this data stream using the corresponding decryption method and the decryption key formed at step 78. Note that, as master key 60 is modified through the exclusive-OR with the EMI or other copy control-related bits prior to encrypting and transmitting content, it is essentially impossible to determine the master key by tampering with the data. The seemingly small change in master key 60, involving only its two least-significant bits in the exemplary embodiment, results in a much greater change in the encrypted data stream. Also note that the EMI or other copy control-related bits delivered to IEEE-1394 interface device 44 over (unsecure) PCI bus 50 are implicitly validated or authenticated. That is, any tampering to the data so delivered will result in a failure to correctly decrypt at IEEE-1394 interface device 44. Thus, the EMI bits cannot be successfully tampered with.

In instances in which IEEE-1394 interface device 44 is the source device, and SoC 34 is the sink device, the modified secure inter-chip transport method illustrated in FIG. 4 can be used. This method is modified from that described above with regard to FIG. 3 to account for the fact that, in the illustrated embodiment, IEEE-1394 interface device 44 does not act as a bus master on PCI bus 50. To work around that fact, at step 86 IEEE-1394 interface device 44 sets an internal register (not shown) to reflect the EMI bits (which were embedded in the content that IEEE-1394 interface device 44 presumably received via connector 54 from some external device such as a digital video recorder), and at step 88 IEEE-1394 interface device 44 raises an interrupt to SoC 34 on PCI bus 50. At step 90, SoC 34 reads the register in IEEE-1394 interface device 44 via PCI bus 50 to obtain the EMI bits and then clears the interrupt.

When, as indicated by step 92, IEEE-1394 interface device 44 detects that the interrupt has been cleared, it uses the EMI bits to create an encryption key at step 94 in the same manner as described above with regard to step 74 (FIG. 3). It waits or delays a predetermined time interval, as indicated by step 96, to allow SoC 34 sufficient time to form its decryption key. As indicated by step 98, SoC 34 creates the decryption key in the same manner as described above with regard to step 78 (FIG. 3).

As indicated by step 100, IEEE-1394 interface device 44 encrypts the (content) data stream using the key formed at step 94 and transmits it via serial bus 52 to SoC 34. As indicated by step 102, SoC 34 receives and decrypts this data stream using the decryption key formed at step 98.

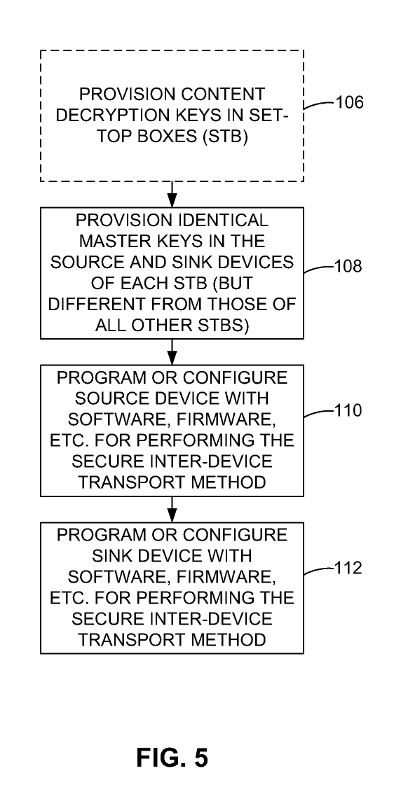

A method for making a source device and sink device of the types described above can be included as part of the overall method by which a set-top box or other multimedia content delivery device is made. As illustrated in FIG. 5, at the time STB 32 is manufactured, in addition to provisioning it with the conventional decryption key or keys as indicated by step 106, its source and sink devices are provisioned with the two identical master keys 60 and 68 (FIG. 2), as indicated by step 108. As described above, master keys 60 and 68 can be stored in SoC 34 and IEEE-1394 interface device 44, respectively, or stored in memory 48, or stored in any other suitable manner in which SoC 34 and IEEE-1394 interface device 44 can access them.

Master keys 60 and 68 are unique in the sense that no keys identical to them are provisioned in any other STB manufactured. Thus, if an unscrupulous person discovers keys 60 and 68 (e.g., by examining the circuitry internal to STB 32), only the security of STB 32 is compromised and not that of other STBs that have been manufactured.

As indicated by steps 110 and 112, the source device and sink device, respectively, are further programmed or configured with software code 62 and 70, respectively. It should be noted that software code 62 and 70, as stored in memory or on other computer-readable media, constitute a “computer program product” as that term is used in the patent lexicon.

In accordance with another embodiment of the invention, data can be securely transferred between SoC 34 and transcoder 45 in a manner similar to that described above with regard to FIGS. 3-4, which relates to transferring data between SoC 34 and to IEEE-1394 interface device 44. In this embodiment, consider as an example the data to be transferred between SoC 34 and transcoder 45 to be content that is already present in STB 32, stored in encrypted form. For example, in a case of transferring data from SoC 34 to transcoder 45, the data can be transferred from a disk or other device (e.g., of memory devices 48) in which it has been stored. Each stored item of content, such as a movie, is conventionally stored in an STB in encrypted form, encrypted with a content key uniquely associated with that content item. Conventionally, data stored in encrypted form in an STB may be decrypted before being transferred between chips of modules internal to the STB, such as an SoC and transcoder, in the STB. (Although not relevant to the present invention, persons skilled in the art to which the invention relates understand that a conventional transcoder is a device that can perform de-coding and re-encoding for various purposes, such as resolution reduction or enhanced data compression.)

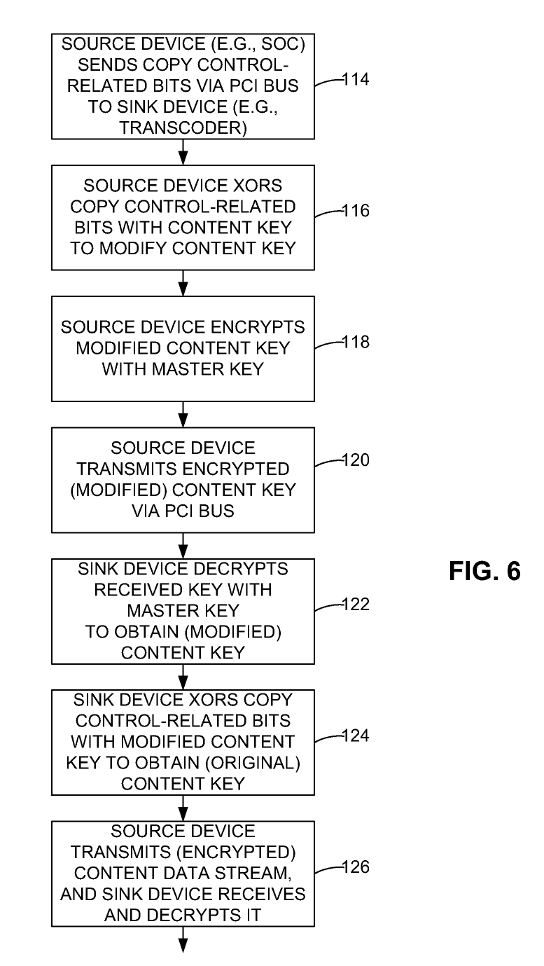

In accordance with the invention, however, although it is suitable for SoC 34 to perform the above-described method, in which the (already conventionally encrypted) data would be, prior to transferring it to transcoder 45, further encrypted using a key formed by the exclusive-OR of master key 60 and copy control-related bits associated with that data, this method is not preferred because it does not take advantage of the fact that the data to be transferred already exists in encrypted form. Accordingly, a method for securely transferring (content) data between SoC 34 (or a similar chip or module) and transcoder 45 (or a similar chip or module), is illustrated in FIG. 6. As in the embodiment described above with regard to FIG. 3, in this embodiment one device acts as a data source, and the other acts as a data sink.

Although not shown for purposes of clarity, transcoder 45 includes logic elements suitable for effecting the method, such as a processor, working memory, and software or data elements, similar to those described above as being included in IEEE-1394 interface device 44, including a transcoder master key and transcoder inter-chip security software code. As in the above-described embodiment, the transcoder master key can be identical to SoC inter-chip security master key 60.

As indicated by step 114, the source device sends copy control-related bits to the sink device. In this embodiment of the invention, the copy control-related bits can include resolution settings, bit rate settings or other information relating to copying data to or from a transcoder or similar device. For example, the source device (e.g., SoC 34) sends copy control-related lower resolution settings or lower bit rate settings for transcoding the stored content to the sink device (e.g., transcoder 45) via the (unsecure) PCI bus 50. As indicated by step 116, the source device modifies the content key associated with that content by performing a logical operation between those control bits and that content key. In the exemplary embodiment, the logical operation is an exclusive-OR, which is performed between the control bits and the least-significant bits of the content key. As indicated by step 118, the source device (e.g., SoC 34) encrypts that modified content key with master key 60 and, as indicated by step 120, transmits the encrypted (modified) content key to the sink device (e.g., transcoder 45) via PCI bus 50. As in the embodiment described above, any suitable encryption algorithm, such as AES-128, can be used.

As indicated by step 122, the sink device (e.g., transcoder 45) receives and decrypts the (modified) content key using the corresponding decryption method and its master key. (The master keys used by SoC 34 and transcoder 45 are identical.) As indicated by step 124, the sink device then restores the modified content key to its original form, by performing the same logical operation as performed by the source device at step 116. For example, transcoder 45 can perform an exclusive-OR operation between the control bits and the least-significant bits of the content key.

As indicated by step 126, the source device (e.g., SoC 34) obtains the (encrypted) content from storage and transmits to the sink device (e.g., transcoder 45) without decrypting it via bus 47. The sink device receives and decrypts the content using the content key obtained at step 124.

The methods shown in FIGS. 3, 4 and 6 may be implemented in a general, multi-purpose or single-purpose processor. Such a processor will execute instructions, either at the assembly, compiled or machine-level, to perform that process. Those instructions can be written by one of ordinary skill in the art following the descriptions of FIGS. 3, 4 and 6 and stored or transmitted on a computer readable medium. The instructions may also be created using source code or any other known computer-aided design tool. A computer readable medium may be any medium capable of carrying those instructions and includes hard-wired logic, random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that various changes and substitutions can be made to the systems, devices and methods described herein without departing from the spirit and scope of the invention as defined by the appended claims and their full scope of equivalents.

What is claimed is:

1. A method for securely transferring content between a source device and a sink device in a multimedia content delivery device, the source device and sink device each having access to identical master keys, the method comprising:
transferring a plurality of copy control-related bits from the source device to the sink device in the multimedia content delivery device, the copy control-related bits associated with secure content processed by the multimedia content delivery device;
the source device performing a logical combination of the master key and the copy control-related bits to form an encryption key;
the sink device performing the logical combination of the master key and the copy control-related bits to form a decryption key identical to the encryption key;
the source device encrypting the content using the encryption key to form encrypted content;
the source device transmitting the encrypted content to the sink device; and
the sink device decrypting the encrypted content using the decryption key.

2. The method claimed in claim 1, wherein the method is performed after content arriving at the multimedia content delivery device from a service provider network is decrypted.

3. The method claimed in claim 1, further comprising:
receiving an instruction to copy content; and
responding to the instruction to copy content in accordance with the EMI bits.

4. The method claimed in claim 1, wherein the logical combination is exclusive-or (XOR).

5. The method claimed in claim 1, wherein:
the copy control-related bits are Digital Transmission Content Protection (DTCP) Encryption Mode Indicator (EMI) bits;
the source device performing a logical combination of a master key and the copy control-related bits comprises performing an exclusive-or (XOR) between the EMI bits and two least-significant bits of the master key; and
the sink device performing a logical combination of the master key and the copy control-related bits comprises performing an XOR between the EMI bits and two least-significant bits of the master key.

6. The method claimed in claim 1, wherein transferring a plurality of copy control-related bits from the source device to the sink device comprises:
the source device storing the copy control-related bits in an internal register;
the source device raising an interrupt detectible by the sink device; and
the sink device reading the copy control-related bits from a register on the source device in response to detecting the interrupt.

7. A method for securely transferring a content key between a source device and a sink device in a multimedia content delivery device, the source device and sink device each having access to identical master keys, the method comprising:
transferring a plurality of copy control-related bits from the source device to the sink device in the multimedia content delivery device, the copy control-related bits associated with secure content processed by the multimedia content delivery device;
the source device performing a logical combination of a content key and the copy control-related bits to form a modified content key;
the source device encrypting the modified content key using the master key to form an encrypted modified content key;
the source device transmitting the encrypted modified content key to the sink device;
sink device decrypting the encrypted modified content key using the master key; and
the sink device performing a logical combination of the copy control-related bits and the decrypted modified content key to form another key identical to the content key.

8. The method claimed in claim 7, wherein the logical combination is exclusive-or (XOR).

9. The method claimed in claim 7, wherein the copy control-related bits are selected from the group consisting of: resolution and data rate.

10. The method claimed in claim 7, further comprising the sink device decrypting the secure content using said another key.

11. The method claimed in claim 10, wherein the step of decrypting the secure content using said another key comprises decrypting data existing in multimedia content delivery device data storage in encrypted form.

12. A system for securely transferring content between a source device and a sink device in a multimedia content delivery device, the source device and sink device having access to identical master keys, the system comprising:
a source device having processing logic programmed or configured to:
transfer a plurality of copy control-related bits to a sink device over a first bus, the content copy-related bits associated with a secure content stream processed by the multimedia content delivery device;
perform a logical combination of a master key and the copy control-related bits to form an encryption key;
encrypt the content stream using the encryption key to form an encrypted content stream;
transmit the encrypted content stream to the sink device over a second bus in the multimedia content delivery device; and
a sink device having processing logic programmed or configured to:
perform the logical combination of the master key and the copy control-related bits to form a decryption key identical to the encryption key; and
decrypt the encrypted content stream using the decryption key.

13. The system claimed in claim 12, wherein the method is performed after data arriving at the multimedia content delivery device from a service provider network is decrypted.

14. The system claimed in claim 12, wherein the logical combination is exclusive-or (XOR).

15. The system claimed in claim 12, wherein:
the copy control-related bits are Digital Transmission Content Protection (DTCP) Encryption Mode Indicator (EMI) bits;
the source device processing logic is programmed or configured to perform a logical combination of the master key and the copy control-related bits by being programmed or configured to perform an exclusive-or (XOR) between the EMI bits and two least-significant bits of the master key; and
the sink device processing logic is programmed or configured to perform a logical combination of the master key and the copy control-related bits by being programmed or configured to perform an XOR between the EMI bits and two least-significant bits of the master key.

16. The system claimed in claim 12, wherein the source device processing logic is further programmed or configured to wait a predetermined time interval between initiating transfer of a plurality of copy control-related bits and transmission of the encrypted content stream to the sink device.

17. The system claimed in claim 12, wherein:
the source device has processing logic further programmed or configured to:
store the copy control-related bits in an internal register;
raise an interrupt detectible by the sink device; and
the sink device processing logic is further programmed or configured to read the copy control-related bits from a register in the source device via the first bus in response to detecting the interrupt.

18. A system for securely transferring a content key between a source device and a sink device in a multimedia content delivery device, comprising:
a source device having access to a master key and having processing logic programmed or configured to:
transfer a plurality of copy control-related bits to the sink device in the multimedia content delivery device, the copy control-related bits associated with secure content processed by the multimedia content delivery device;
produce a modified content key by performing a logical combination of the copy control-related bits and the content key;
produce an encrypted modified content key in response to the master key and the modified content key;
transmit the encrypted modified content key in the multimedia content delivery device; and
a sink device having access to the master key and having processing logic programmed or configured to:
receive the encrypted modified content key from the source device;
decrypt the encrypted modified content key in response to the master key; and
perform a logical combination of the copy control-related bits and the decrypted modified content key to form another key identical to the content key.

19. The system claimed in claim 18, wherein the logical combination is exclusive-or (XOR).

20. The system claimed in claim 19, wherein the copy control-related bits are selected from the group consisting of: resolution and data rate.

21. The system claimed in claim 20, further comprising the sink device decrypting the secure content using said another key.

22. The method claimed in claim 21, wherein decrypting the secure content using said another key comprises decrypting data existing in multimedia content delivery device data storage in encrypted form.
